(19) United States
(12) Patent Application Publication
(10) Pub. No.: US 2021/0270366 A1
(43) Pub. Date: Sep. 2, 2021

(54) Actuating Device for Actuating Shifting Elements

(71) Applicant: ZF Friedrichshafen AG, Friedrichshafen (DE)

(72) Inventors: Stefan Beck, Eriskirch (DE); Martin Brehmer, Tettnang (DE); Johannes Kaltenbach, Friedrichshafen (DE); Fabian Kutter, Kressbronn (DE); Thomas Martin, Weissensberg (DE); Matthias Horn, Tettnang (DE)

(21) Appl. No.: 17/274,008

(22) PCT Filed: Aug. 5, 2019
(86) PCT No.: PCT/EP2019/071003

§ 371 Date: Mar. 5, 2021

(30) Foreign Application Priority Data
Sep. 7, 2018 (DE) 10 2018 215 230.6

(51) Int. Cl. F16H 63/30; F16H 63/16

(52) U.S. Cl. CPC F16H 63/3069; F16H 2063/3079; F16H 2063/3073; F16H 63/16

(57) ABSTRACT

An actuating unit for actuating shift elements of a transmission (G) includes a shaft (1) at least partially configured as a hollow shaft and at least three shift elements (A, B, C, D). At least two of the at least three shift elements are spatially separated from each other by at least one of the three shift elements. A first actuating element (S1) is configured as a hollow shaft and a second actuating element (S2) is guided within the first actuating element (S1). A mechanical coupling of the two actuating elements (S1, S2) with the at least three shift elements (A, B, C) takes place through a plurality of recesses (11, 12, 13) in the shaft (1) and through at least one recess (21) in the first actuating element (S1) in such a way that the at least two shift elements (A, B, C, D) spatially separated from each other are actuatable by precisely one of the two actuating elements (S1, S2).

### CROSS-REFERENCE TO RELATED APPLICATION

The present application is related and has right of priority to German Patent Application No. 102018215230.6 filed in the German Patent Office on Sep. 7, 2018 and is a nationalization of PCT/EP2019/071003 filed in the European Patent Office on Aug. 5, 2019, both of which are incorporated by reference in their entirety for all purposes.

### FIELD OF THE INVENTION

The invention relates generally to an actuating unit for actuating shift elements of a transmission and to a transmission with an actuating unit of this type.

### BACKGROUND

From the prior art, it is known to actuate multiple shift elements in manual transmissions or in dual clutch transmissions with only one single actuator. Here, two shift elements, for one gear pair in each case, located next to each other are actuated with one common actuator via a selector fork, which is connected to a gear change rod and engages onto a gear change sleeve. The selector forks engage “from the outside” onto the gear change sleeve in this case. Selector forks are also known, however, which can actuate shift elements located next to each other from the inside, from within the central shaft. A solution of this type is lacking for shift elements spatially separated from one another.

### SUMMARY OF THE INVENTION

Example aspects of the present invention provide an actuating unit for actuating shift elements, which actuates shift elements spatially separated from one another with only one actuator.

Example aspects of the invention therefore provide an actuating unit with a shaft at least partially configured as a hollow shaft and with at least three shift elements, each of which is associated with the shaft. At least one shift element spatially separates the at least two other shift elements.

The shift elements are preferably form-locking shift elements. The shift elements can be clutches, which, upon actuation, each synchronize, if necessary, the particular components of the transmission joined directly to the clutches, with respect to turning motions of the and particular components, thereafter, connect the components to each other in a rotationally fixed manner. The shift elements can also be brakes, however, which, upon actuation, decelerate the components joined directly thereto to a standstill, if necessary, and, thereafter, fixes them.

Actuators are utilized for automatically actuating the shift elements. The electric motor usually utilized as a drive unit is actuated. The disengagement and engagement of the shift elements can be carried out via the electric motor. The actuators can actuate, for example, in a hydraulic or electro-mechanical manner.

Within the meaning of the invention, a “shaft” is understood to be a rotatable component of the transmission, via which associated components of the transmission are rotationally fixed to each other or via which a connection of this type is established upon actuation of an appropriate shift element. The shaft can connect the components to each other axially or radially or even both axially and radially in this case. The particular shaft can also be present as an intermediate piece, via which a particular component is connected, for example, radially.

Example aspects of the invention provide two actuating elements guided within the shaft for actuating the shift elements, wherein a first actuating element is designed as a hollow shaft and a second actuating element is guided within the first actuating element. The particular actuating element is preferably a gear change rod or a selector fork.

The mechanical coupling of the two actuating elements with the at least three shift elements takes place via a plurality of recesses in the shaft and via at least one recess in the first actuating element in such a way that at least the two shift elements spatially separated from each other are always actuatable by precisely one of the two actuating elements. The two actuating elements as well as the shaft always have the same rotational speed in this case.

The mechanical connection of the second actuating element with one of the shift elements arranged radially outside the shaft and coaxially to the shaft extends, for all intents and purposes, in the radial direction through two mutually corresponding recesses of the first actuating element and the shaft. The recesses are preferably oblong holes or bore holes.

The at least two further mechanical couplings can be configured in such a way that the first actuating element is connected to the two remaining shift elements. The at least two mechanical couplings can also be configured in such a way, however, that the first actuating element is mechanically associated with one shift element and the second actuating element is associated with a further shift element.

Providing this solution allows for a greater leeway in the design of transmissions, since not only shift elements located next to one another, but also spatially separated shift elements, which are each associated with the same shaft, can now be actuated with only one actuating element. In other words, only one actuator is necessary for the spatially separated shift elements. This also reduces costs and weight, since fewer actuators are necessary for actuating the actuating elements. In addition, for example, shift elements with a smaller diameter can be provided, since the shift elements are actuated “from the inside out” and not from the outside.

An actuating unit is preferred, wherein the shaft for the mechanical coupling of the actuating elements with the at least three shift elements includes at least three recesses and the first actuating element includes at least one recess, wherein the at least one recess of the first actuating element corresponds to at least one of the three recesses of the shaft. It is particularly preferred when the diameter of the oblong hole of the first actuating element is twice as great as the diameter of the corresponding oblong hole of the shaft.

It has proven to be structurally highly stable to provide three recesses for at least three shift elements.

In addition, an actuating unit is preferred, wherein a mechanical coupling of the first actuating element with the at least one shift element of the at least three shift elements takes place through a second recess of the shaft. In addition, a mechanical coupling of the second actuating element with one further shift element of the at least three shift elements takes place through a first recess of the shaft. A mechanical coupling of the second actuating element with one further shift element of the at least three shift elements also takes place through a third recess of the shaft and through a recess of the first actuating element.

This example embodiment provides that the first actuating element actuates the middle shift element or the middle shift elements. The second actuating element, however, actuates the two outer shift elements.

In addition, an actuating unit is preferred, wherein a mechanical coupling of the second actuating element with the at least first shift element takes place through a second recess of the shaft and through a recess of the first actuating element. A mechanical coupling of the first actuating element with the second shift element of the at least three shift elements takes place through a first recess of the shaft. A mechanical coupling of the first actuating element with the second shift element takes place through a third recess of the shaft, however.

This example embodiment provides that the second actuating element actuates the middle shift element or the middle shift elements. The first actuating element, however, actuates the two outer shift elements.

An actuating unit is further preferred, wherein an at least fourth shift element is provided, wherein the third shift element and the fourth shift element are configured as a double shift element, which spatially separates the first shift element from the second shift element.

If the third shift element and the fourth shift element are configured as a double shift element, the already present second recess in the shaft for the mechanical coupling of the third shift element with one of the two actuating elements can also take place for the mechanical coupling of the fourth shift element with the same actuating element. Therefore, only two actuating elements and, thereby, also only two actuators are necessary in order to actuate four shift elements, of which two are spatially separated from one another.

In addition, an actuating unit is preferred, wherein an at least fourth shift element is provided, wherein the four shift elements are each designed as a single shift element. The shaft includes at least four recesses for the mechanical coupling of the actuating elements with the four shift elements. One of the two actuating elements, in particular the first actuating element, is associated with two first shift elements spatially separated from each other in this case.

In a first example embodiment with four single shift elements, it is preferred that the other of the two actuating elements, in particular the second actuating element, is associated with two second shift elements spatially separated from each other.

In a second example embodiment with four single shift elements, it is preferred that the other of the two actuating elements, in particular the second actuating element, is associated with the two shift elements that are not spatially separated from each other.

The provision of four single shift elements makes a fourth recess necessary. The advantage of four recesses in the case of four shift elements is that the recesses can each be dimensioned smaller, since a shorter shift stroke is necessary as compared to the double shift element. This increases the shaft strength.

In addition, an actuating unit is preferred, wherein the second actuating element is designed as a hollow shaft. As a result, the weight can be further reduced. In addition, space for an oil lubrication or an oil duct is made possible as a result.

The recesses for the passage through the shaft for the actuation of the shift elements can lie in a plane. An actuating unit is particularly preferred, however, wherein the recesses are arranged at the circumference of the shaft, offset with respect to one another in each case by a certain angle. As a result, the strength of the shaft is increased.

Example aspects of the invention also provide a transmission for a motor vehicle with the above-described actuating unit.

### BRIEF DESCRIPTION OF THE DRAWINGS

Example aspects of the invention are explained in greater detail with reference to the following figures. Wherein:

FIG. 1 shows a diagrammatic view of a motor vehicle drive train with a transmission with an actuating unit according to a first example embodiment of the invention;

FIG. 2 shows a diagrammatic view of a second exemplary transmission, in which the actuating unit according to the invention can be utilized:

FIG. 3 shows a diagrammatic view of an actuating unit in a first example embodiment of the invention;

FIG. 4 shows a diagrammatic view of an actuating unit in a second example embodiment of the invention;

FIG. 5 shows a diagrammatic view of an actuating unit in a third example embodiment of the invention;

FIG. 6 shows a diagrammatic view of an actuating unit in a fourth example embodiment of the invention;

FIG. 7 shows a diagrammatic view of an actuating unit in a fifth example embodiment of the invention;

FIG. 8 shows a diagrammatic view of an actuating unit in a sixth example embodiment of the invention;

FIG. 9 shows a diagrammatic view of an actuating unit in a seventh example embodiment of the invention; and

FIG. 10 shows a diagrammatic view of an actuating unit in an eighth example embodiment of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

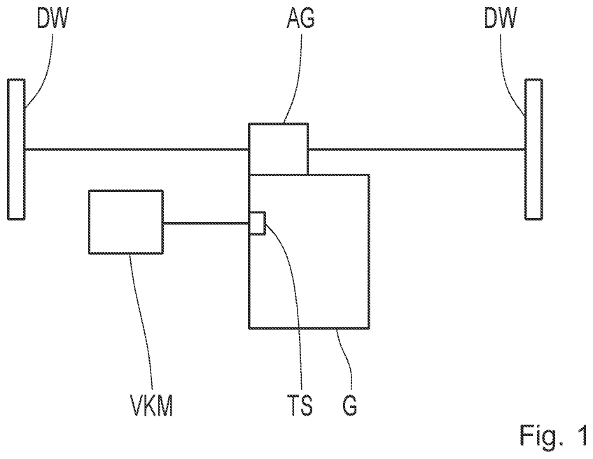

FIG. 1 shows a diagrammatic view of a motor vehicle drive train of a motor vehicle with an actuating unit according to a first example embodiment, wherein, in the motor vehicle drive train, an internal combustion engine VKM is connected to a transmission G via an intermediate torsional vibration damper TS. Connected downstream from the transmission G, on the output end thereof, is a differential gear AG, via which drive power is distributed to driving wheels DW of a drive axle of the motor vehicle. The transmission G and the torsional vibration damper TS are arranged in a common housing of the transmission G in this case, into which the differential gear AG can then also be integrated. As is also apparent in FIG. 1, the internal combustion engine VKM, the torsional vibration damper TS, the transmission G, and also the differential gear AG are aligned transversely to a direction of travel of the motor vehicle.

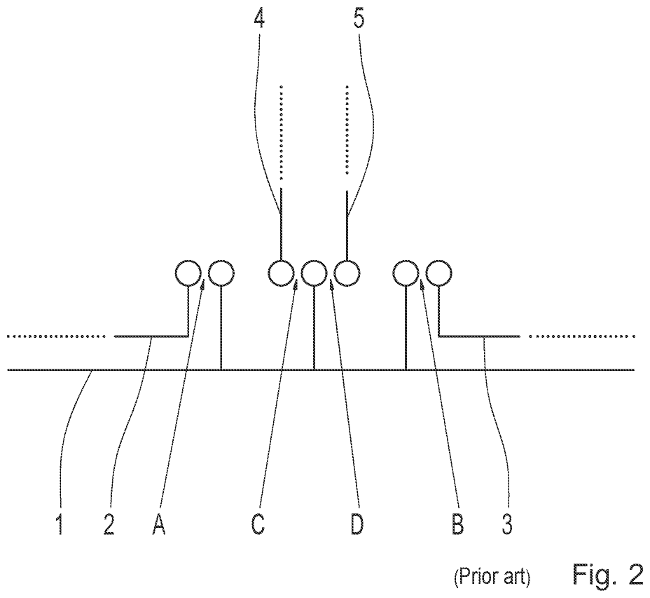

FIG. 2 shows, by way of example, a transmission G from the prior art, of the type that can be utilized in the motor vehicle drive train according to FIG. 1, in which the actuating unit can be utilized. A shaft 1 in the form of an input shaft of the transmission G are apparent. The transmission G includes four shift elements, namely a first shift element A, a second shift element B, a third shift element C, and a fourth shift element D. The shift elements A and B are spatially separated from each other by the shift elements C and D. It is known to actuate the shift elements C and D located next to each other by a single actuator. Previously, an actuation by the same actuator was not possible for the shift elements A and B located on the outside.

According to this example, the shift elements A, B, C, D are associated with the same shaft 1, namely the input shaft 1, i.e., each shift element connects the input shaft 1 with another shaft. In this way, the shaft 1 is rotationally fixed

to a second shaft 2 by the first shift element A,

to a third shaft 3 by the second shift element B,

to a fourth shaft 4 by the third shift element C, and

to a fifth shaft 5 by the fourth shift element D.

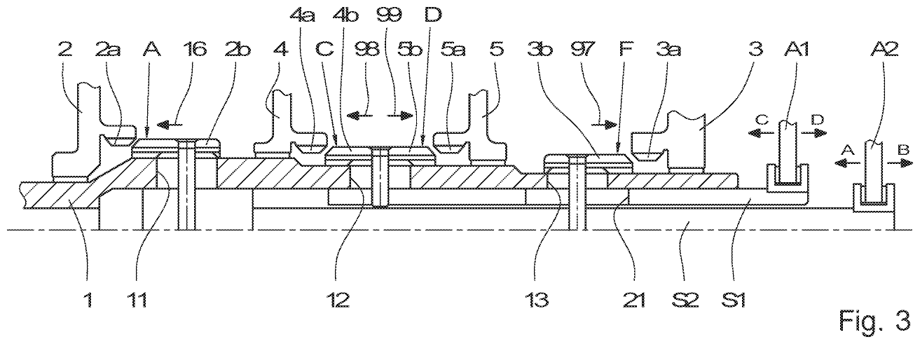

FIG. 3 shows a schematic of the actuating unit in a first example embodiment of the invention. As is apparent, the actuating unit includes a shaft 1, four shift elements A, B, C, D, two actuating elements configured as control rods S1, S2, and two actuators A1, A2.

In the present case, the shaft 1 is an input shaft of a transmission, which is configured as a hollow shaft. A first control rod S1 is also configured as a hollow shaft, whereas a second control rod S2 is configured as a solid shaft. Both control rods S1, S2 are guided within the shaft 1, wherein the second control rod S2 is guided within the first control rod S1. As viewed radially from the outside, the sequence results: shaft 1, first control rod S1, second control rod S2. The first control rod S1 is actuatable by a first actuator A1, whereas the second control rod S2 is actuatable by a second actuator A2.

The actuators A1, A2 are arranged on a side of the second shift element B facing away from the first shift element A.

The four shift elements A, B, C, D are each a dog clutch and, as viewed from the shaft 1, are arranged axially in the sequence: first shift element A, third shift element C, fourth shift element D, second shift element B. As is readily apparent, the shift elements A and B are spatially separated from each other by the shift elements C and D.

Within the meaning of the invention, the term “axially” means an orientation in the direction of an axis, along which the shift elements are arranged coaxially to one another. “Radially” is then understood to mean an orientation in the direction of the diameter of a shaft that lies on this axis.

In the actuated, i.e., engaged condition, the shift elements A, B, C, and D rotationally fix the shaft 1 to another shaft in each case. In this way,

the first shift element A connects the shaft 1 to a second shaft 2,

the second shift element B connects the shaft 1 to a third shaft 3,

the third shift element C connects the shaft 1 to a fourth shaft 4, and

the fourth shift element D connects the shaft 1 to a fifth shaft 5.

For the form-fitting connections, the shafts 2, 3, 4, and 5 include tooth systems 2a, 3a, 4a, and 5a, respectively, which correspond to tooth systems 2b, 3b, 4b, and 5b, respectively, of the dogs. The mode of operation of dog clutches is known from the prior art, and so it will not be discussed in greater detail here.

Each control rod S1, S2 can actuate precisely two shift elements. As is to be easily derived from FIG. 2, the first control rod S1 actuates the third shift element C and the fourth shift element D, which are configured as a double shift element in the present case. The second control rod S2, however, actuates the shift elements A, B spatially separated from each other.

In order to actuate the third shift element C, the first actuator A1, starting from a non-actuated condition, moves the first gear change rod S1 in the arrow direction 98, i.e., toward the left in the viewing direction. In order to actuate the fourth shift element D, the first actuator A1, starting from a non-actuated condition, moves the first gear change rod S1 in the arrow direction 99, i.e., toward the right in the viewing direction.

In order to actuate the first shift element A, the second actuator A2, starting from a non-actuated condition, moves the second gear change rod S2 in the arrow direction 96, i.e., toward the left in the viewing direction. In order to actuate the second shift element B, the second actuator A2, starting from a non-actuated condition, moves the second gear change rod S2 in the arrow direction 97, i.e., toward the right in the viewing direction.

In order to ensure that the shift elements A through D are actuatable from within the shaft 1, the shaft 1 includes three recesses, as mentioned above, namely a first recess 11, a second recess 12, and a third recess 13. In addition, the first control rod S1 includes a recess 21. The recesses are oblong holes in the present case.

A mechanical coupling or connection of the first shift element A with the second control rod S2 takes place through the first oblong hole 11 of the shaft 1. A mechanical coupling of the shift elements C, D with the first control rod S1 takes place through the second oblong hole 12 of the shaft 1. Due to the configuration as a double shift element, the mechanical connection of two shift elements is possible through only one oblong hole. The mechanical coupling of the second shift element B, however, takes place through the two mutually corresponding, i.e., essentially aligned oblong holes 13, 21 of the shaft 1 and of the first control rod S1, respectively.

The particular shift element A, B, C, and D is rotationally fixed to the control rod S1, S2 via a section (not described in greater detail), which is guided through the particular oblong hole 11, 12, 13, and 21.

The shift elements A and B, on the one hand, and C and D, on the other hand, are collectively controlled. This means, when the shift element A is engaged, the shift element B is simultaneously disengaged, and vice versa. The same also applies for the shift elements C and D.

In order to ensure that the one control rod does not inadvertently move the other control rod and, thereby, possibly engage or disengage a shift element, the oblong hole 21 of the first control rod S1 has a larger diameter than the third oblong hole 13 of the shaft 1. In the present case, the diameter is twice as great. As is also apparent, the two control rods are aligned with respect to each other in such a way that the two oblong holes 13, 21 are situated coaxially to each other when the shift elements are in a non-actuated condition.

With the actuating unit, the two shift elements A, B arranged on the outside are actuatable by only one gear change rod and by only one actuator. Therefore, only two actuators A1, A2 are necessary for a transmission with four shift elements A, B, C, D, wherein two of these are spatially separated.

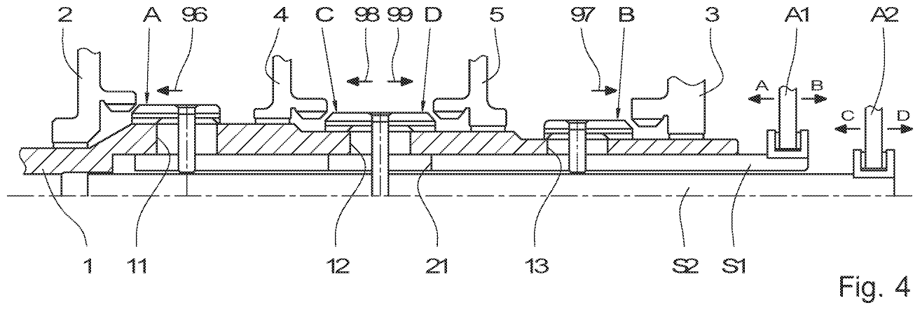

FIG. 4 shows a schematic of the actuating unit in a second example embodiment of the invention. In contrast to the example embodiment according to FIG. 3, the first control rod S1 actuates the two shift elements A and B. The shift elements C and D are actuated by the second control rod S2, however. For this purpose, the oblong hole 21 is arranged in the first control rod S1 in such a way that the oblong hole 21 corresponds to the second oblong hole 12 of the shaft 1. The oblong holes 11, 12, 13 remain unchanged.

A mechanical coupling of the first shift element A with the first control rod S1 therefore takes place through the first oblong hole 11 of the shaft 1 via a section. A mechanical coupling of the shift element B with the first control rod S1 therefore takes place through the third oblong hole 13 of the shaft 1 via another section. However, the mechanical coupling of the third shift element C and the fourth shift element D with the second control rod S2 takes place through the two mutually corresponding, i.e., essentially aligned oblong holes 12, 21 of the shaft 1 and of the first control rod S1, respectively, via a further section.

In order to actuate the third shift element C, the second actuator A2, starting from a non-actuated condition, therefore moves the second gear change rod S2 in the arrow direction 98, i.e., toward the left in the viewing direction. In order to actuate the fourth shift element D, the second actuator A2, starting from a non-actuated condition, moves the second gear change rod S2 in the arrow direction 99, i.e., toward the right in the viewing direction.

In order to actuate the first shift element A, the first actuator A1, starting from a non-actuated condition, moves the first gear change rod S1 in the arrow direction 96, i.e., toward the left in the viewing direction. In order to actuate the second shift element B, the first actuator A1, starting from a non-actuated condition, moves the first gear change rod S1 in the arrow direction 97, i.e., toward the right in the viewing direction. For the rest, the example variant according to FIG. 4 corresponds to the example embodiment according to FIG. 3, and therefore reference is made to the description thereof.

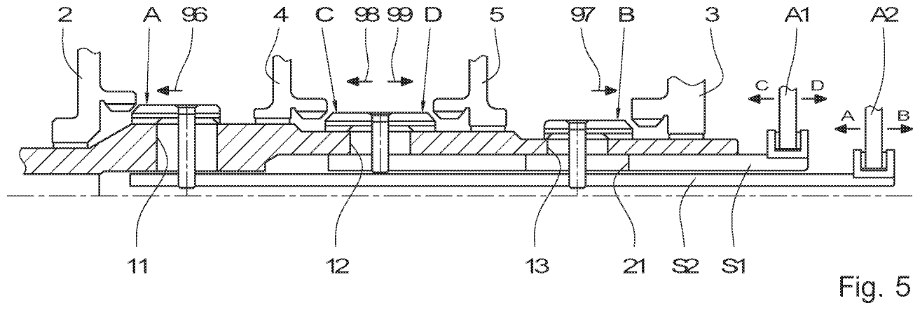

FIG. 5 shows a schematic of the actuating unit in a third example embodiment of the invention. In contrast to the example embodiment according to FIG. 3, the second control rod S2 is configured as a hollow shaft. This allows for a lighter weight and offers space for an oil lubrication (not represented in the present case). For the rest, the example variant according to FIG. 5 corresponds to the example embodiment according to FIG. 3, and therefore reference is made to the description thereof.

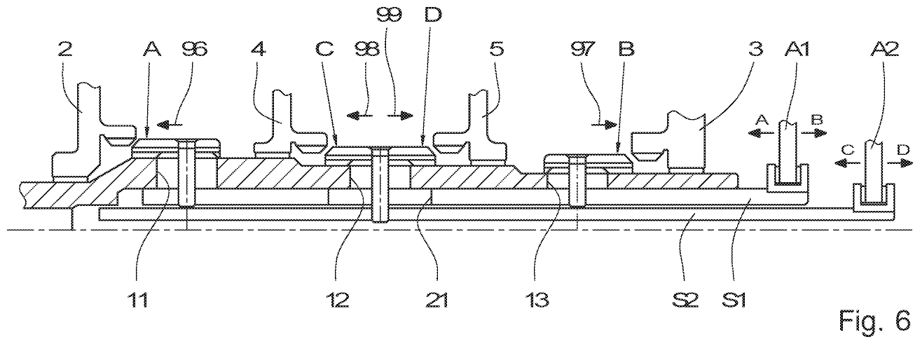

FIG. 6 shows a schematic of the actuating unit in a fourth example embodiment of the invention. In contrast to the example embodiment according to FIG. 3, the first control rod S1 actuates the two shift elements A and B. The shift elements C and D are actuated by the second control rod S2, however. This corresponds to the example embodiment according to FIG. 4. In addition, the second control rod S2 is configured as a hollow shaft, cf. the example embodiment according to FIG. 5. In other words, this is a combination of the example embodiments according to FIGS. 4 and 5. For the rest, the example variant according to FIG. 6 corresponds to the example embodiment according to FIGS. 4 and 3, and therefore reference is made to the description thereof.

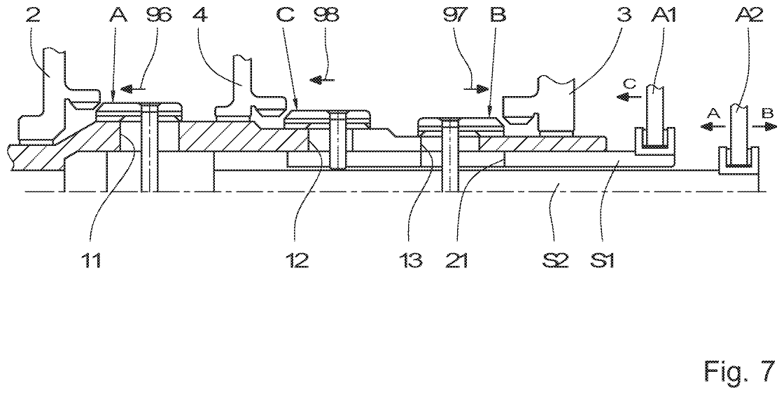

FIG. 7 shows a schematic of the actuating unit in a fifth example embodiment of the invention. In contrast to the example embodiment according to FIG. 3, only three shift elements A, B, C are present. The third shift element C, which is designed as a single shift element in the present case, spatially separates (as in FIG. 3) the shift elements A and B from each other. As one further difference, the second oblong hole 12 has a smaller diameter than in the example variant according to FIG. 3. The diameter of the oblong hole 21 is also smaller. This is, namely, only one and a half (1.5) times of the diameter of the oblong hole 13. The advantage of this example embodiment lies in a shorter shift stroke and in a higher shaft strength. For the rest, the example variant according to FIG. 7 corresponds to the example embodiment according to FIG. 3, and therefore reference is made to the description thereof.

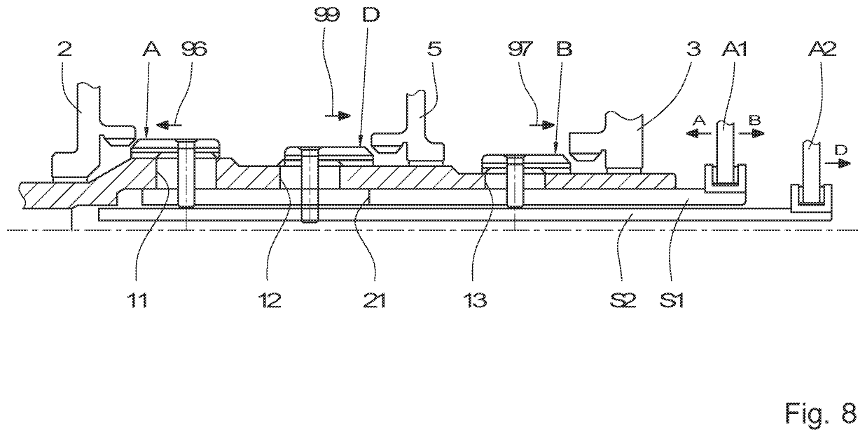

FIG. 8 shows a schematic of the actuating unit in a sixth example embodiment of the invention. In contrast to the example embodiment according to FIG. 3, only three shift elements A, B, D are present. The fourth shift element D, which is designed as a single shift element in the present case, spatially separates (as in FIG. 3) the shift elements A and B from each other. As one further difference, the second oblong hole 12 has a smaller diameter than in the example variant according to FIG. 3. The advantage of this example embodiment lies in a shorter shift stroke and in a higher shaft strength. For the rest, the example variant according to FIG. 8 corresponds to the example embodiment according to FIG. 4, and therefore reference is made to the description thereof.

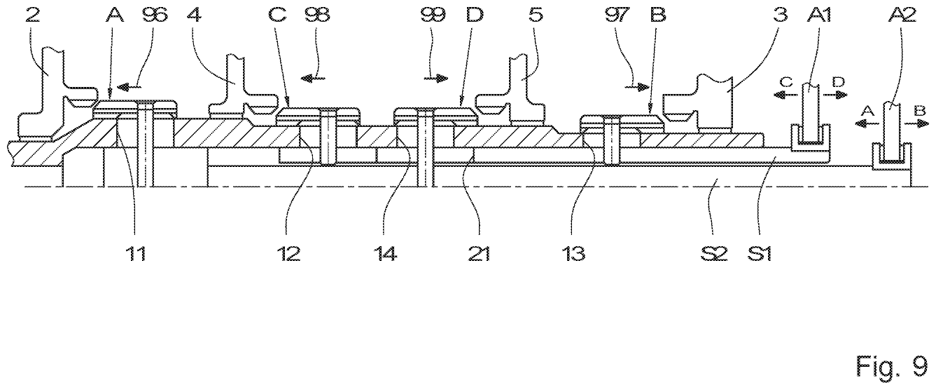

FIG. 9 shows a schematic of the actuating unit in a seventh example embodiment of the invention. In contrast to the example embodiment according to FIG. 3, the shift elements C and D are each configured as a single shift element. This makes a fourth oblong hole 14 in the shaft 1 necessary. The fourth oblong hole 14 is arranged axially between the second oblong hole 12 and the third oblong hole 13. The fourth shift element D is mechanically coupled with the second control rod S2 through the fourth oblong hole 14 by a further section.

In contrast to the example embodiment according to FIG. 3, the fourth oblong hole 14 of the shaft 1 now corresponds to the oblong hole 21 of the first control rod S1. In addition, in contrast to the example embodiment according to FIG. 3, the shift element B is mechanically connected with the first control rod S1 through the third recess 13.

As in FIG. 3, the shift element A is mechanically connected with the second control rod S2 through the first recess 11. As in FIG. 3, the shift element C is mechanically connected with the first control rod S1 through the second recess 12 (as in FIG. 4).

In this way, four spatially separated shift elements, namely A and D, on the one hand, and C and D, on the other hand, can be actuated by precisely two actuators A1, A2. For the rest, the example variant according to FIG. 9 corresponds to the example embodiment according to FIGS. 3 and 4, and therefore reference is made to the description thereof.

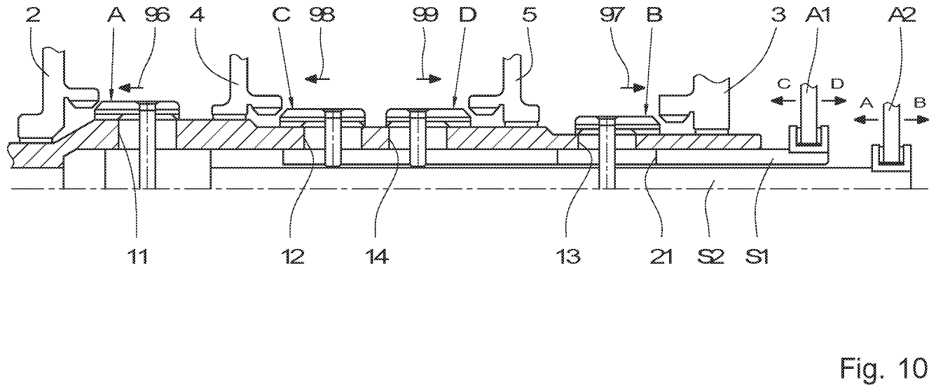

FIG. 10 shows a schematic of the actuating unit in an eighth example embodiment of the invention. In contrast to the example embodiment according to FIG. 3, the shift elements C and D are each configured as a single shift element. This makes a fourth oblong hole 14 in the shaft 1 necessary. The fourth oblong hole 14 is arranged axially between the second oblong hole 12 and the third oblong hole 13. As in FIG. 3, the oblong hole 21 of the first control rod S1 corresponds to the third oblong hole 13 of the shaft 1.

The first control rod S1 actuates, as in the example embodiment according to FIG. 3, the third shift element C and the fourth shift element D, whereas the second control rod actuates the first shift element A and the second shift element B. The fourth shift element D is mechanically coupled with the first control rod S1 through the oblong hole 14 of the shaft 1 by a section. For the rest, the example variant according to FIG. 10 corresponds to the example embodiment according to FIG. 3, and therefore reference is made to the description thereof.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE CHARACTERS

1 shaft, input shaft, central shaft
2 second shaft
3 third shaft
4 fourth shaft
5 fifth shaft
2a tooth system of the second shaft
3a tooth system of the third shaft
4a tooth system of the fourth shaft
5a tooth system of the fifth shaft
2b tooth system of the first shift element A
3b tooth system of the second shift element B
4b tooth system of the third shift element C
5b tooth system of the fourth shift element D
11 first recess, oblong hole, bore hole
12 second recess, oblong hole, bore hole
13 third recess, oblong hole, bore hole
14 fourth recess, oblong hole, bore hole
21 fifth recess, oblong hole, bore hole
96 arrow direction
97 arrow direction
98 arrow direction
99 arrow direction

A first shift element, dog

B second shift element, dog

C third shift element, dog

D fourth shift element, dog

A1 first actuator

A2 second actuator

S1 first actuating element, first control rod

S2 second actuating element, second control rod

1-15. (canceled)

16. An actuating unit for actuating shift elements of a transmission (G), comprising:
a shaft (1) at least partially configured as a hollow shaft;
at least three shift elements (A, B, C, D) associated with the shaft (1), wherein two or more of the at least three shift elements are spatially separated from each other by one or more of the three shift elements; and
a first actuating element (S1) and a second actuating element (S2) disposed within the shaft (1) for actuating the at least three shift elements (A, B, C, D),
wherein the first actuating element (S1) is configured as a hollow shaft, and the second actuating element (S2) is disposed within the first actuating element (S1),
wherein the first and second actuating elements (S1, S2) are mechanically coupled with the at least three shift elements (A, B, C, D) through a plurality of recesses (11, 12, 13, 14) in the shaft (1) and through at least one recess (21) in the first actuating element (S1) such that the two or more of the at least three shift elements spatially separated from each other are actuatable by precisely one of the first and second actuating elements (S1, S2).

17. The actuating unit of claim 16, wherein the shaft (1) defines at least three recesses (11, 12, 13), the first actuating element (S1) defines at least one recess (21), and the at least one recess (21) of the first actuating element (S1) corresponds with at least one of the at least three recesses (11, 12, 13) of the shaft (1).

18. The actuating unit of claim 16, wherein:
the one or more of the three shift elements comprises a first shift element, and the two or more of the at least three shift elements comprises a second shift element (A) and a third shift element (B);
the first actuating element (S1) is mechanically coupled with the first shift element through a second recess (12) of the shaft (1); and
the second actuating element (S2) is mechanically coupled with the second shift element (A) through a first recess (11) of the shaft (1); and
the second actuating element (S2) is mechanically coupled with the third shift element (B) through a third recess (13) of the shaft (1) and through a recess (21) of the first actuating element (S1).

19. The actuating unit of claim 16, wherein:
the one or more of the three shift elements comprises a first shift element (C, D), and the two or more of the at least three shift elements comprises a second shift element (A) and a third shift element (B);
the second actuating element (S2) is mechanically coupled with the first shift element (C, D) through a second recess (12) of the shaft (1) and through a recess (21) of the first actuating element (S1);
the first actuating element (S1) is mechanically coupled with the second shift element (A) through a first recess (11) of the shaft (1); and
the first actuating element (S1) is mechanically coupled with the third shift element (B) through a third recess (13) of the shaft (1).

20. The actuating unit of claim 16, wherein:
the at least three shift elements comprises a first shift element (A), a second shift element (B), a third shift element (C), and a fourth shift element (D);
the third shift element (C) and the fourth shift element (D) are configured as a double shift element; and
the double shift element is disposed between the first shift element (A) and the second shift element (B).

21. The actuating unit of claim 16, wherein:
the at least three shift elements comprises a first shift element (A), a second shift element (B), a third shift element (C), and a fourth shift element (D);
each of the first, second, third, and fourth shift elements (A, B, C, D) are configured as a single shift element;
the shaft (1) defines at least four recesses (11, 12, 13, 14); and
one of the first and second actuating elements (S1, S2) is associated with two of the first, second, third, and fourth shift elements (A, B, C, D) that are spatially separated from each other (A, B; A, D; C, B).

22. The actuating unit of claim 21, wherein the other of the two actuating elements (S2, S1) is associated with the other two of the first, second, third, and fourth shift elements (A, B, C, D), and the other two of the first, second, third, and fourth shift elements (A, B, C, D) are also spatially separated from each other.

23. The actuating unit of claim 21, wherein the other of the two actuating elements (S2, S1) is associated with the other two of the first, second, third, and fourth shift elements (A, B, C, D), and the other two of the first, second, third, and fourth shift elements (A, B, C, D) are adjacent to each other.

24. The actuating unit of claim 16, wherein each of the at least three shift elements (A, B, C, D) is a constant-mesh shift element.

25. The actuating unit of claim 16, wherein the second actuating element (S2) is configured as a hollow shaft.

26. The actuating unit of claim 16, wherein each of the plurality of recesses (11, 12, 13, 14) in the shaft (1) and the at least one recess (21) in the first actuating element (S1) is an oblong hole.

27. The actuating unit of claim 16, wherein the plurality of recesses (11, 12, 13, 14) in the shaft (1) and the at least one recess (21) in the first actuating element (S1) are arranged at a circumference of the shaft (1) and are offset with respect to one another by an angle.

28. The actuating unit of claim 17, wherein a diameter of the at least one recess (21) of the first actuating element (S1) is greater than a diameter of the at least one of the at least three recesses (11, 12, 13) of the shaft (1).

29. The actuating unit of claim 28, wherein the diameter of the at least one recess (21) of the first actuating element (S1) is double the diameter of the at least one of the at least three recesses (11, 12, 13) of the shaft (1).

30. A transmission (G) for a motor vehicle comprising the actuating unit of claim 16.
